(19) United States
(12) Patent Application Publication
(10) Pub. No.: US 2025/0085697 A1
(43) Pub. Date: Mar. 13, 2025

(54) DATA INTERFACE DEVICE FOR UPDATING CONTROL PROGRAMS, UPDATE SYSTEM, MANUFACTURING SYSTEM, METHOD FOR UPDATING CONTROL PROGRAMS AND METHOD FOR CONTROLLING A NUMERICALLY CONTROLLED MACHINE TOOL

(71) Applicant: DMG MORI Digital GmbH, Bielefeld (DE)

(72) Inventors: Henrik PULS, Hamburg (DE); Stefan AMES, Leopoldshöhe (DE); Christoph WEISS, Steingaden (DE)

(21) Appl. No.: 18/830,331

(22) Filed: Sep. 10, 2024

(30) Foreign Application Priority Data
Sep. 12, 2023 (DE) 102023124562.7

(51) Int. Cl. G05B 19/418

(52) U.S. Cl. CPC G05B 19/4185; G05B 19/41845; G05B 2219/31215

(57) ABSTRACT

A data interface device for updating control programs of a control device of a numerically controlled machine tool, comprising a first interface module configured for data transmission with a control program database, and a second interface module configured for data transmission with one or more control devices. The data interface device is configured to receive an update data record from the control program database via the first interface module and to transmit a configuration data record to a control device via the second interface module, said configuration data record causing said control device to update a control program stored in a memory unit of the control device on the basis of the transmitted configuration data record. The data interface device is configured for updating control programs of at least two different control.

### CROSS-REFERENCE TO RELATED APPLICATIONS

This application claims priority from DE 102023124562.7, filed Sep. 12, 2023. The entire content of the priority application is incorporated herein by reference.

### DESCRIPTION

### Technical Field

The present invention relates to a data interface device for updating control programs, an update system, a manufacturing system, a method for updating control programs and a method for controlling a numerically controlled machine tool.

### BACKGROUND OF THE INVENTION

In the field of automated manufacturing, numerically controlled machine tools (NC or CNC machine tools) are usually used, the components of which are controlled by one or more control devices of the machine tool in order to perform their respective function in the course of workpiece machining.

In this way, a human interaction on the machine tool in the course of workpiece machining is already reduced to a minimum.

The manufacturers of the machine tools continuously further develop the control programs on which the control is based in order to eliminate program errors or to improve the control itself, for example, the control can thereby be made even more precise, more accurate, faster or more energy-saving.

The loading of the new or revised control program, i.e., the updating, is usually still carried out by a service technician of the manufacturer, who personally arrives at the customer, which is not only impracticable, but also time-consuming and cost-intensive. The manual updating of the control programs by the customer himself is ruled out here, since the complexity of the control device(s) of the machine tool requires an individual configuration of the updating process.

In order to improve this procedure and, inter alia, to be able to dispense with an on-site use of a service technician, solutions for an online update are known in the prior art, in which information relating to a new control program is obtained online from a database of the manufacturer of the machine tool and is subsequently loaded via a network on the machine tools or on the control devices thereof.

For this purpose, a method for updating a plurality of machine tools is known from EP 2 407 841 A2, in which software packages are transmitted from a central server of the machine tool manufacturer.

However, this update system quickly reaches its limits in the case of machine tools configured differently and on a customer-specific basis and in this case still requires the intervention of a service technician, who still has to manually set certain configurations and parameters of the updating process for different machine tools.

### SUMMARY

An objective of the present invention is therefore to provide a more efficient option with which the control of machine tools can always be kept up-to-date, in particular in order to implement an improved machining quality of workpieces in this way.

To achieve this objective, a data interface device for updating control programs according to claim 1, an update system according to claim 12 and a method for updating control programs according to claim 14 as well as a manufacturing system according to claim 13 and a method for controlling a machine tool according to claim 15 are provided.

The other dependent claims relate to preferred embodiments of the methods or of the machine tool, which can each be provided by themselves or in combination.

According to a first aspect of the invention, a data interface device for updating control programs of a control device of a numerically controlled machine tool is provided, comprising a first interface module configured for data transmission with a control program database, and a second interface module configured for data transmission with one or more control devices. The data interface device is configured to receive an update data record from the control program database via the first interface module and to transmit a configuration data record to a control device via the second interface module, said configuration data record causing said control device to update a control program stored in a memory unit of the control device on the basis of the transmitted configuration data record. The data interface device is configured for updating control programs of at least two different control devices and for this purpose comprises a processing module which is configured to generate, on the basis of a received update data record, at least a first configuration data record which can be read by a first control device of the at least two control devices and a second configuration data record which can be read by a second control device of the at least two control devices.

In this way, a data interface device is created which, independently of hardware-or software-based implementation of individual control devices, can update a control program there on the basis of a generic update data record.

The control devices can be understood here as control devices of separate machine tools or as control devices of separate components (structural or functional groups) of an individual machine tool or of different machine tools. Structural or functional groups can be, inter alia, machine axes (linear, round or pivot axes), drives for work spindles or auxiliary systems, such as, for example, a cooling lubricant supply or a process monitoring system.

The data interface device is suitable for updating different control devices, which means that a configuration data record for the first control device can generally not be read or executed by the second control device and vice versa.

“Different” is to be understood here as meaning that the said control devices are not structurally identical, but are implemented in different ways and under certain circumstances also perform entirely different functions in the machine tool.

The update data record is to be understood as an accumulation of electronically storable and transmittable data which contain information relating to new control programs, for example relating to new settings, control algorithms etc.

The configuration data record for the respective control device is to be understood as an accumulation of electronically storable and transmittable data which can generally only be read and executed by the type of control device for which the configuration data record has been generated. The configuration data records for the different control devices can thus differ in their data format, the installation instructions contained and the sequence thereof, the programming language and the like.

Each control device, independently of whether it is provided as a central control device for controlling the entire machine tool or whether it controls only an individual structural or functional group of the machine tool as a subassembly control device, is usually implemented differently depending on the manufacturer.

By way of example and not exhaustively, they can differ in the programming language to be used, in the implementation of the control program or in the types of communication interfaces for controlling individual structural and functional groups.

Until now, it has not been possible to provide a generic update data record on the basis of which control programs of different control devices could be updated. To date, components to be updated and an associated update data record thus had to be selected manually on the basis of the individual equipment of a machine tool. This is no longer necessary due to the data interface device provided.

As a result, update operations can be carried out fully automatically for a multiplicity of different control devices without the presence of a technician, which considerably reduces the downtimes of the machine tools and also associated costs and additionally ensures that the most up-to-date control program is always present on the control device.

The processing module of the data interface device can be provided as part of the first and/or of the second interface module or separately therefrom.

The interface modules and the data processing module are preferably embodied as processor-based data processing devices which, taken by themselves, can have a plurality of electronic interfaces for data transmission and also internal memories, for example main memories.

The data interface device is preferably configured to communicate with N further different control devices via the second interface module, where N≥1. In this case, the data interface device is configured for updating control programs of the first and of the second and of the N further control devices, wherein the processing module is configured to generate, on the basis of the received update data record, the first and second configuration data record and N further configuration data records which can be read by the respective control devices, and to transmit the respective configuration data records to the associated control device via the second interface module.

In a preferred embodiment, the second interface module is configured to receive inventory data records from the first and/or from the second control device which contain information relating to the control program installed on the respective control device, and to store said inventory data records in particular in a memory module of the data interface device.

As a result, the data interface device can advantageously function as a collection point in which all information relating to control programs currently installed on the first and the second control device is collected.

The said inventory data record relating to one of the two control devices contains, for example, information relating to a current version number of the control program or of individual program modules of the control program, the date of the last update or a listing of currently installed program modules. In this case, a control program can comprise a plurality of program modules which provide different functionalities. In this case, the said program modules can be added to or removed from the control program as desired in order thus to extend the functionalities of the machine tool on the software side.

In a preferred embodiment, the processing module is configured to generate the first and/or second configuration data record additionally on the basis of the received inventory data records of the associated control device.

As a result, the configuration data record is generated on the basis of the control program already installed on the control device in order thus to avoid unnecessary updates and, for example, to update only those program modules for which a new, improved or revised version is actually available in the control program database.

Likewise, it is also possible for no configuration data record to be created if the control program of one of the control devices is already up-to-date.

In a preferred embodiment, the first interface module is configured to select the update data record to be received from the control program database on the basis of the received inventory data records.

As a result, the update data record most suitable for the update can be downloaded, with the result that duplications can be avoided, which in turn increases the transmission speed and reduces a memory utilization of the data interface device.

In a preferred embodiment, the control program database is provided on a separate server and the first interface module is configured to communicate therewith via an inter-or intranet connection.

As a result, the control program database can, for example, be provided externally and, independently of its location, supply a multiplicity of data interface devices with corresponding update data records.

In a preferred embodiment, the data interface device is partially or entirely cloud-based, in particular the processing module is cloud-based.

As a result, the data interface device itself can be provided decentrally, with the result that processing-power-intensive operations, such as, for example, the generation of the configuration data records, can be carried out in the cloud, which usually offers a higher processing power than local data processing devices.

In a preferred embodiment, the at least two control devices are parts of the same numerically controlled machine tool and are configured to control different components of the machine tool.

In a preferred embodiment, the first control device is part of a first numerically controlled machine tool and the second control device is part of a second numerically controlled machine tool.

In a preferred embodiment, the configuration data records generated by the processing module contain installation instructions which can be executed by the respective control device.

In a preferred embodiment, the configuration data records generated additionally contain an electronic signature.

In this way, the authenticity of the configuration data records on the control devices can be ensured in order to be able to distinguish them reliably from malware, for example. Thus, for example, the installation instructions contained in a configuration data record are executed on the control devices only if the electronic signature contained corresponds to a predefined or fixed signature.

Preferably, the update data record also contains an electronic signature, wherein in particular the electronic signatures of the configuration data records generated by the processing module are created on the basis of the electronic signature of the update data record.

Further preferably, configuration data records are only created if the electronic signature contained in the update data record corresponds to a predefined or fixed signature.

In this way, the risk of malware input via the first interface module can also be prevented.

In a preferred embodiment, the data interface device furthermore comprises an input module for detecting user inputs, via which input module in particular an updating process for a control program of a control device can be initiated.

As a result, an updating process can be initialized manually by an operator in order to carry it out, for example, at the best possible time at which the machine tool does not need to carry out or only has to carry out a small number of work orders.

The data interface device preferably comprises a time module which initializes an updating process by the data interface device at regular time intervals. As a result, it is ensured that the control programs are updated as promptly as possible if a newer or improved version is available.

According to a second aspect, an update system for use with machine tools is provided, comprising at least one data interface device according to the first aspect or according to one of the preferred embodiments thereof and at least one control program database which is coupled via the first interface module of the data interface device to the latter for data transmission.

In this way, an update system is provided which offers the advantages of the data interface device according to the invention in order to be able to be implemented without problems in existing manufacturing systems.

The control program database is preferably provided on a separate server and communicates with the data interface device via an inter-or intranet connection.

According to a third aspect, a manufacturing system is provided which comprises at least one update system according to the second aspect and at least one first and one second control device which are different and are both coupled via the second interface module of the data interface device of the update system to the latter for data transmission.

In this way, an entire manufacturing system with the advantageous functionality of the data interface device according to the invention can be provided which is now set up not only for fully automated workpiece machining but also for fully automatic updating of the control programs used for this purpose.

The first and the second control device can be implemented as control devices of separate machine tools or as control devices of separate components (structural or functional groups) of an individual machine tool or of different machine tools.

As a result, it can be ensured in particular that the respective control devices always have the current software or the current control program which generally permits a more accurate or more energy-saving or even faster control in comparison with a previous version and thus permits more efficient workpiece machining.

The update system preferably comprises a multiplicity of data interface devices according to the first aspect or according to one of the preferred embodiments thereof, which are all coupled to the control program database.

The data interface devices can, for example, be used in different factories and in this case all be supplied with update data records via the same control program database.

According to a fourth aspect, a method for updating control programs of a control device of a numerically controlled machine tool, by means of a data interface device, is provided, in particular by means of a data interface device according to the first aspect or one of the preferred embodiments thereof, comprising receiving an update data record by a first interface module of the data interface device from a control program database, selecting at least one control device to be updated from a set of at least two different control devices, generating a configuration data record for the selected control device, said configuration data record causing said control device to update a control program stored in a memory unit of the selected control device, on the basis of the received update data record by a processing module of the data interface device, transmitting the generated configuration data record to the selected control device by means of a second interface module of the data interface device; and updating the control program on the selected control device on the basis of the transmitted configuration data record.

The method provided offers the possibility, independently of hardware-or software-based implementation of individual control devices, of updating a control program there on the basis of a generic update data record.

The further advantages associated therewith substantially correspond to the advantages already described in the course of the data interface device, for which reason a renewed reproduction is dispensed with at this point. The same applies to the preferred embodiments of the method described below, which substantially represent the process-technical implementations of the advantageous embodiment of the data interface device already described.

The method preferably furthermore comprises receiving an inventory data record from the first and/or receiving an inventory data record from the second control device, which inventory data records each contain information relating to the control program installed on the respective control device, by means of the second interface module and in particular storing said inventory data record in a memory module of the data interface device.

Preferably, the configuration data record is generated on the basis of the received inventory data records of the associated, selected control device and on the basis of the received update data record.

The method preferably furthermore comprises selecting the update data record to be received from the control program database on the basis of the received inventory data records via the first interface module.

The method preferably furthermore comprises electronically signing the generated configuration data record.

According to a fifth aspect, a method for controlling a numerically controlled machine tool is provided, comprising updating a control program of a control device of the numerically controlled machine tool using a method according to the fourth aspect or one of the preferred embodiments thereof, and controlling the machine tool by means of the control device on the basis of the updated control program.

In this way, workpiece machining in the course of which the machine tool is correspondingly controlled can be provided, which workpiece machining always takes place on the basis of a current control program which generally permits a more accurate or more energy-saving or even faster control in comparison with a previous version and thus permits more efficient workpiece machining.

Controlling the machine tool is to be understood here as controlling one or more actuators or components of the machine tool, for example linear, round or pivot axes, drives for work spindles or auxiliary systems which are controlled on the basis of the control program.

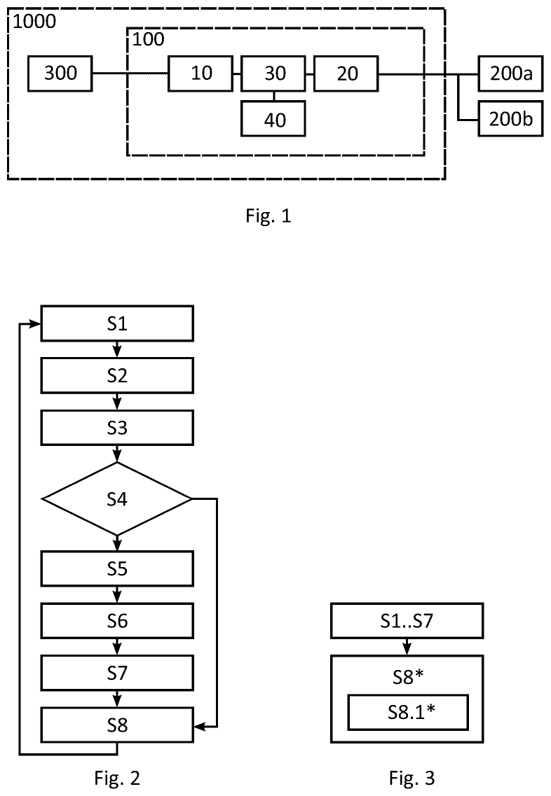

FIG. 1 shows a schematic view of an exemplary embodiment of the production system according to the invention which comprises an exemplary embodiment of an update system which in turn comprises an exemplary embodiment of the data interface device.

FIG. 2 shows a schematic flow diagram of an exemplary embodiment of the method according to the invention for updating control programs.

FIG. 3 shows a schematic flow diagram of an exemplary embodiment of the method according to the invention for controlling a machine tool.

It is emphasized that the present invention is in no way limited to the exemplary embodiments described below and the embodiment features thereof. The invention furthermore comprises modifications of the exemplary embodiments mentioned, in particular those which emerge from modifications and/or combinations of individual or a plurality of features of the exemplary embodiments described within the scope of protection of the independent claims.

### DETAILED DESCRIPTION OF THE FIGURES

FIG. 1 shows a schematic view of an exemplary embodiment of the production system according to the invention which comprises an exemplary embodiment of an update system 1000 which in turn comprises an exemplary embodiment of the data interface device 100.

The production system comprises the update system 1000 and the first and second control devices 200a, 200b connected thereto.

The first and second control device 200, 200b are different and can be implemented as control devices of separate machine tools or as control devices of separate components (structural or functional groups) of an individual machine tool or of different machine tools.

In the present case, the two control devices 200a, 200b are control devices of different components of the same machine tool.

The update system 1000 comprises a control program database 300 and a data interface device 100.

The control program database 300 is cloud-based and provided on a separate server which can be reached via an intranet or Internet connection.

The data interface device 100 comprises here a first interface module 10 which is configured for data transmission with the control program database 300 and a second interface module 20 which is coupled to the first and the second control device 200a, 200b and is configured for data transmission. Furthermore, the data interface device 1000 comprises a processing module 30 which, in the present exemplary embodiment, is embodied as a separate component, but can also be embodied as part of the first or second interface module 10, 20.

The data interface device 100 is configured to receive an update data record from the control program database 300 via the first interface module 10.

The processing module 30 is then configured to generate, on the basis of the received update data record, at least a first configuration data record which can be read by the first control device 200a and a second configuration data record which can be read by the second control device 200b.

Furthermore, the data interface device 100 is configured to transmit the configuration data records generated to the respective control devices 200a, 200b via the second interface module 20, said configuration data records respectively causing said control devices to update a control program stored in a memory unit of the respective control device 200a, 200b on the basis of the respectively transmitted configuration data record.

In this way, the data interface device 100 offers a possibility, independently of the individual hardware-or software-based implementation of the two control devices 200a, 200b, of updating a control program there on the basis of the generic update data record from the control program database 300.

Until now, it has not been possible to provide a generic update data record on the basis of which control programs of different control devices could be updated. To date, components to be updated and an associated update data record thus had to be selected manually on the basis of the individual equipment of a machine tool. This is no longer necessary due to the data interface device 100 provided.

The data interface device 100 furthermore comprises an input module 40 for detecting user inputs. As a result, an operator can manually initiate an updating process for one or more control devices 200a, 200b on the data interface device 100, for example if the associated machine tool is currently not needed.

FIG. 2 shows a schematic flow diagram of an exemplary embodiment of the method according to the invention for updating control programs on a first and/or a second control device of a numerical machine tool with the aid of a data interface device. The first and the second control device are different here.

In step S1, an inventory data record is received from the first and an inventory data record is received from the second control device, each inventory data record containing information relating to the control program installed on the respective control device, by means of the second interface module.

In step S2, an update data record is received by a first interface module of the data interface device from a control program database.

In step S3, at least one control device to be updated is selected from a set of at least two different control devices.

In step S4, the received inventory data record from step S1 for the control device selected in step S3 is compared with the received update data record from step S2.

If a comparison result from step S4 is positive and no update of the control program has to be performed on the selected control device, step S8 follows. However, if the comparison result is negative, step S5 follows.

In step S5, a configuration data record is generated for the control device selected in step S3, said configuration data record causing said control device to update a control program stored in a memory unit of the selected control device, on the basis of the received update data record from step S2 and of the received inventory data record for the selected control device from step S1 by a processing module of the data interface device.

In step S6, the configuration data record generated in step S5 is transmitted to the control device selected in step S3 by means of a second interface module of the data interface device.

In step S7, the control program is updated on the selected control device on the basis of the configuration data record transmitted to said control device in step S4.

In step S8, there is a pause of predefined duration before the method begins again with step S1.

The method enables a fully automatable possibility for updating control programs on a multiplicity of different control devices.

In an alternative embodiment, all control devices coupled to the data interface device are selected in step S3 and the following steps S4 to S7 are carried out for each control device either in a parallelized or sequential sequence.

FIG. 3 shows a schematic flow diagram of an exemplary embodiment of the method according to the invention for controlling a numerically controlled machine tool, comprising a prior updating of a control program of the control device of the machine tool.

Steps S1 to S7 correspond to the steps of the updating method from FIG. 2, in the course of which a control program is updated on the control device selected in step S3.

After the updating method, the machine tool, of which the control device selected in step S3 is part, is controlled in step S8* by means of the selected control device on the basis of the control program updated in step S7.

The controlling here comprises at least one substep S8.1*, in which a component of the machine tool is actuated on the basis of output values of the updated control program of the control device selected in step S3, in particular in order to implement a machining step of a workpiece machining by the machine tool in this way.

In this way, workpiece machining in the course of which the machine tool is correspondingly controlled can be provided, said workpiece machining always taking place on the basis of a current control program which generally permits a more accurate or more energy-saving or even faster control in comparison with a previous version and thus permits more efficient workpiece machining.

Exemplary embodiments of the present invention and the advantages thereof have been described in detail above with reference to the accompanying figures.

It is emphasized again that the present invention is in no way limited to the exemplary embodiments described above and the embodiment features thereof. The invention furthermore comprises modifications of the exemplary embodiments mentioned, in particular those which emerge from modifications and/or combinations of individual or a plurality of features of the exemplary embodiments described within the scope of protection of the independent claims.

### LIST OF REFERENCE SIGNS

10 first interface module
20 second interface module
40 processing module
40 input module
100 data interface device
200a first control device
200b second control device
300 control program database
1000 update system

1. A data interface device for updating control programs of a control device of a numerically controlled machine tool, comprising:
a first interface module configured for data transmission with a control program database; and
a second interface module configured for data transmission with one or more control devices;
wherein the data interface device is configured to receive an update data record from the control program database via the first interface module and to transmit a configuration data record to a control device via the second interface module, said configuration data record causing said control device to update a control program stored in a memory unit of the control device on the basis of the transmitted configuration data record;
characterized in that
the data interface device is configured for updating control programs of at least two different control devices and for this purpose comprises a processing module which is configured to generate, on the basis of a received update data record, at least a first configuration data record which can be read by the first control device of the at least two control devices and a second configuration data record which can be read by the second control device of the at least two control devices.

2. The data interface device according to claim 1, characterized in that
the second interface module is configured to receive inventory data records from the first and/or the second control device which contain information relating to the control program installed on the respective control device, and to store said inventory data records in particular in a memory module of the data interface device.

3. The data interface device according to claim 2, characterized in that
the processing module is configured to generate the first and/or second configuration data record additionally on the basis of the received inventory data records of the associated control device.

4. The data interface device according to claim 2, characterized in that
the first interface module is configured to select the update data record to be received from the control program database on the basis of the received inventory data records.

5. The data interface device according to claim 1, characterized in that
the control program database is provided on a separate server and the first interface module is configured to communicate therewith via an inter-or intranet connection.

6. The data interface device according to claim 1, characterized in that
the data interface device is partially or entirely cloud-based.

7. The data interface device according to claim 1, characterized in that
the at least two control devices are parts of the same numerically controlled machine tool and are configured to control different components of the machine tool.

8. The data interface device according to claim 1, characterized in that
the first control device is part of a first numerically controlled machine tool and the second control device is part of a second numerically controlled machine tool.

9. The data interface device according to claim 1, characterized in that
the configuration data records generated by the processing module contain installation instructions which can be executed by the respective control device.

10. The data interface device at least according to claim 9, characterized in that
the configuration data records generated additionally contain an electronic signature.

11. The data interface device according to claim 1, characterized in that
the data interface device furthermore comprises an input module for detecting user inputs, via which input module in particular an updating process for a control program of a control device can be initiated.

12. The data interface device according to claim 1, wherein the data interface device is part
of an update system for use with machine tools, the update system comprising: at least one control program database which is coupled via the first interface module of the data interface device to the latter for data transmission.

13. The data interface device of claim 12, wherein the update system is part of a production system, comprising:
at least one first and one second control devices which are coupled via the second interface module of the data interface device of the update system to the latter for data transmission.

14. A method for updating control programs of a control device of a numerically controlled machine tool, by means of a data interface device, comprising the steps:
receiving an update data record by a first interface module of the data interface device from a control program database;
selecting at least one control device to be updated from a set of at least two different control devices;
generating a configuration data record for the selected control device, said configuration data record causing said control device to update a control program stored in a memory unit of the selected control device, on the basis of the received update data record by a processing module of the data interface device;
transmitting the generated configuration data record to the selected control device by means of a second interface module of the data interface device; and
updating the control program on the selected control device on the basis of the transmitted configuration data record.

15. A method for controlling a numerically controlled machine tool, comprising the steps of:
updating a control program of a control device of the numerically controlled machine tool using a method according to claim 14; and
controlling the numerically controlled machine tool by means of the control device on the basis of the updated control program.
